(19) United States
(12) Patent Application Publication
(10) Pub. No.: US 2007/0259090 A1
(43) Pub. Date: Nov. 8, 2007

(54) Low-calorie foods and process of making the same

(75) Inventors: Jason Arthur Taylor, Bethesda, MD (US); Rebecca Ann Zeltinger, Bethesda, MD (US); John G. Cosby JR., Rehobeth Beach, DE (US)

Correspondence Address: TECHNOLOGY ADVANCEMENT LABS, LLC, 4998 BATTERY LANE, STE. 305, BETHESDA, MD, 20814, US

(73) Assignee: Technology Advancement Labs LLC, Bethesda, MD (US)

(21) Appl. No.: 11/429,507

(22) Filed: May 5, 2006

(51) Int. Cl. A21D 10/00

(52) U.S. Cl. 426/549

(57) ABSTRACT

A novel dough-like mixture made using cellulose and hydrocolloid gums that can be used as a basis for forming a variety of low-calorie foods is disclosed. Methods for producing low-calorie and reduced-starch donuts, fillings, cookies, breads, and many other food products using this dough are also described. Erythritol-based reduced-sugar confectionery items and methods for their production and application, including use in reduced-calorie sweet-tasting bakery goods, are also disclosed. Many of the disclosed foods are low enough in caloric value to be termed “recreational solid foods,” with experiments showing that even ad libitum eating of them results in weight loss.

### FEDERALLY SPONSORED RESEARCH

Not Applicable

### SEQUENCE LISTING OR PROGRAM

Not Applicable

### CROSS REFERENCE TO RELATED APPLICATIONS

Not Applicable

### TECHNICAL FIELD OF THE INVENTION

The present invention pertains to the field of low-calorie or diet food design, and, in particular, to a new class of foods that are very high in cellulose content. The present invention also relates generally to methods of cooking such foods.

### BACKGROUND OF THE INVENTION

There is a large amount of activity in the field of health and nutrition in the context of consuming foods and especially bakery products. The availability of highly flavored food products and undisciplined eating habits when viewed in the light of the sedentary life style of a major segment of society portends an increasingly overweight population.

It is now generally accepted that being overweight is detrimental to one's health. For this reason, many consumers try to reduce their calorie intake. This is amply evident from the present day shopping profile and visibility of a large number of low-calorie (defined herein as a ≧50% caloric reduction as compared to the traditional version of the food per unit weight) and reduced-calorie (defined herein as a nonzero caloric reduction per unit weight) products in the market. Over the past few decades, significant technological progress has been made towards diet products, but substantial success has been largely limited to products such as diet sodas. The development of processed low-calorie solid foods has been an ongoing uphill battle. The USDA's food database lists “BREAD, REDUCED-CALORIE, WHITE” as having only 22% fewer calories per unit of weight than “BREAD, WHITE, COMMERCIALLY PREPARED,” with the more important caloric reduction effect being due merely to differences in portion size.

Most energy in common existing bakery products is starch. A typical calorie profile for conventional bread is 64% starch, 13% sugar, 12% fat, and 11% protein. Protein is becoming increasingly nutritionally desirable. Both sugars and fats can be replaced by substitutes of lower caloric value known to those skilled in the art of food science. However, these substitutes are often found to adversely affect the physical or chemical properties of the dough and baked product, not to mention the health of its consumers. Moreover, a low-calorie full substitute for the starch-containing components of flours and doughs is not found in existing low-calorie food technologies, though much progress has been made.

U.S. Pat. No. 3,979,523 issued to Titcomb et al. provides for reduced calorie bread and a method for making the same. The invention describes that a bread composition that incorporates a cellulose additive in precise amounts to produce a bread product having fewer calories than the comparable standard white bread product. The composition also includes taste enhancements so that the reduced-calorie bread will have the same quality and texture as the standard white bread. However, the amount of cellulose is limited at less than approximately 18%. Moreover, the caloric reduction that is obtained with the product is limited to perhaps 25%.

U.S. Pat. No. 4,668,519 issued to Dartey et al. discloses a new class of low-calorie baked goods and methods for making the same. It provides a process for the preparation of reduced calorie baked goods having the texture, mouth feel, and appearance of conventional baked goods by partially replacing the flour, shortening or fat, and sugar with emulsifiers, polydextroses or polymaltoses and cellulose bulking agents. Caloric reductions of at least 25%, based upon conventional formulations, are achieved with minimal replacement of the sugar component. A tender open cell structure is achieved by controlling the pH of the final baked product with an alkaline agent and by use of multi-component leavening agents. Lump formation in the creaming stage which is normally encountered in the use of polydextroses in dry or powdered form is avoided by mixing the polydextrose in dry form with the dry ingredients (e.g., flour), rather than creaming it as a sugar in conventional cookie production and using an aqueous solution of a soluble polydextrose in the creaming stage. The resultant caloric reduction is again, however, limited.

Beereboom (1979), Brys (1976), and U.S. Pat. No. 3,876,794 discuss agents that can partially replace starch and sugars in normal flour. These products include cellulose, microcrystalline cellulose, xanthan gum, polydextrose, polyglycerol esters, polyoxyethylene fatty acid esters and sucrose polyester. However, Beereboom also points out that foods which contain appreciable quantities of cellulose exhibit poor palatability, texture, and mouth feel. Accordingly, to date, the use of cellulose in foods has been at relatively low levels.

In U.S. Pat. No. 4,219,580 it is taught that cellulose-containing flour, such as crystalline alphacellulose sold under the trade name “Solka-Floc”, and the microcrystalline cellulose sold under the trade name “Avicel,” can only be used up to a replacement level of about 20%, which leads to a caloric reduction in the final baked goods of only about 10%. The taste and texture of baked goods obtained using replacement levels greater than about 20%, it was disclosed, are unsatisfactory.

U.S. Pat. No. 4,042,714 discloses a low-calorie farinaceous composition comprising from about 20-75% by weight of modified polydextrose, from about 2-20% by weight of proteinaceous material, from about 10-40% by weight of cellulose derivatives selected from alphacellulose and microcrystalline cellulose, and from about 5-20% by weight of normal flour.

U.S. Pat. No. 3,867,560 issued to Menzi et al. describes dietetic confectioneries that are prepared from a mixture of carbohydrate, monosaccharides, oligosaccharides, protein, and gelling agents. The gelling agent contains at least 70% by weight of non-assimilable material. The entire amount of the gelling agent in the entire quantity of the mixture is between 12-20% by weight. High fructose corn syrup is used as the assimilable carbohydrate.

U.S. Pat. No. 4,234,611 issued to Kahn et al. discloses one of the more recent products adapted for a wide variety of uses including pastry filling. While such patent teaches high fructose syrup and apples, it does not preclude the use of granular sugars or fat. The apples appear to be used solely as a fruit source. Starch is also an ingredient and the essence of the invention of such patent appears to be the production of a microbiologically stable food, which can be kept at freezer or room temperature for extended periods. The application of heat is necessary in the preparation of such fillers.

The features of the afore cited prior art disclose attempts at making low-calorie bakery products, but suffer from the drawbacks of not reducing the calorie intake by more than about 50% on account of compromises in favor and mouthfeel. Moreover, previous attempts at high (>50%) levels of cellulose have been unsuccessful and have resulted in unpalatable food products. What are needed are very low calorie versions of solid foods that consumers might welcome in the same way that they have embraced calorie-free diet sodas. Heretofore they have been unavailable.

### SUMMARY OF THE INVENTION

The present invention provides a “cellulose-based” dough that addresses the foregoing disadvantages inherent in the above-mentioned prior art and can be used to form a variety of low-calorie foods. The general purpose of the invention is to provide “recreational foods” which are palatable and wholesome yet sufficiently deficient of calories that they can be consumed without affecting one's health, cholesterol, weight, blood pressure, insulin resistance, or overall health.

The notion of a flour-free or low-flour cellulose-based bakery product is unusual. In the present invention, most of the starch that is in normal flour is replaced by a mixture of cellulose; hydrocolloids such as methycellulose, xanthan gum, and hemicellulose; and additional ingredients. In one embodiment, the dry ingredients are mixed with water and kneaded to form a dough. The low-calorie dough composition is then transformed into homogenous dough, followed by cutting and shaping of dough, followed by cooking.

The dough can be baked by conventional means. One cooking method known to be particularly suitable for the present invention is microwave radiation. During cooking, the chemical leavening agents help transform the dough into an aerated fluffy bread. The methycellulose and xanthan gum of the present invention serve a similar purpose that gluten does in a conventional bread: helping to prevent the escape of air from air pockets in the central regions of bakery products.

Additional embodiments of the invention include low-calorie, extruded, crunchy snacks; low-calorie dips; and products in which the said dough serves as a calorie-reducing bulking agent, such as low-calorie structural meat analogues.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a process flow diagram depicting the process for making the low-calorie dough;

FIG. 2 is a flow chart depicting the process for making low-calorie bakery products; and

FIG. 3 is a cross-sectional view of one embodiment of the invention that is a toroidal low-calorie donut and, for comparison, a chocolate-flavored prior art donut.

### DETAILED DESCRIPTION OF THE INVENTION

For the reasons already mentioned, we began a research project to see if it could be possible to create very low-calorie solid foods. At that time, only a tiny percentage of solid foods were truly low in calories. Examples included certain vegetables (e.g., celery), but very few prepared foods. Even many of the fat-free diet products were as much as 4 calories per gram. In a detailed review of dieting habits, we determined that what many dieters really craved were bakery products. We also knew that if a calorie-free bakery product were to be invented, it could be used as a base for many of the other products that led to breakdowns in human dieting attempts. Therefore, our initial pointed objective was just to be able to produce a low-calorie bakery product similar to regular bread. We did not merely wish to reduce the calories slightly. Rather, we wished to reduce them to such an extent that we could eat them recreationally (without influencing body fat or health), much as some people might drink sweetened beverages throughout the day.

In thinking about the above points, we also considered the fact that even if a basic very low-calorie bread product were created, it alone might be unsatisfying. This is because bread is traditionally eaten with relatively high-calorie items such as jellies, frostings, nut butters, bean dips, butter, cheeses, etc. Therefore, unless we also somehow discovered more low-calorie “mimetics” of these products, a prospective dieter eating the low-calorie bread in a normal fashion might actually gain weight. This would be undesirable.

Experiments with a variety of low-calorie substances and methods have been conducted. After several years of research, a breakthrough was made and the first successful prototype was created. From this basic “artificial dough” and baking method, it was then attempted to apply the process to create complete bread-related marketable products/meals. It was then decided to specifically attempt to create a very low-calorie donut/doughnut. Theoretical reasoning was concluded that if one were able to mimic something this “decadent” everything else would be easy. The project was indeed difficult because donuts traditionally contain a high-calorie sugar-based glaze and an optional high-calorie jelly filling. (Here and elsewhere in this document, the expression “x-based” is defined as having x as its heaviest ingredient excluding water.)

When research was initiated, a few low-calorie fillings were already known in the art, but this was not the case for the glaze. Despite this, a means of creating a low-calorie glaze that behaved surprisingly similar to a sugar-water-based glaze was soon successfully discovered. Subsequent research was then done to perfect and enhance this and other bakery products. After successfully creating these low-calorie bakery products, we were able to extend and apply the technology even further to create a robust new class referred to as “cellulose-based” low-calorie solid foods. For some embodiments of the invention, a 90% caloric reduction is achieved on products nearly, though not completely, as savory and satisfying as their traditional, full-calorie counterparts.

In the following description of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is therefore, not to be taken in a limiting sense, and the scope of the present invention is defined only by the appended claims.

Furthermore, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

The exemplary embodiments described herein for illustrative purposes are subject to many variations in terms of ingredients used and food products made. It should be emphasized, however that the present invention is not limited to a particular type of low-calorie product made that is described herein. One embodiment of the present invention involves producing a low-calorie dough from a cellulose-dominant flour followed by cooking in a microwave oven.

Cellulose is a long-chain polymer polysaccharide non-starch carbohydrate of beta-glucose. Cellulose is extremely abundant in nature, being the largest contributor to organic biomass. Cellulose is nontoxic and has less than 0.03 calories per gram. This makes it an ideal candidate for use in low-calorie foods. Alpha cellulose is one form of cellulose. It may be defined as the non-dissolving portion of cellulose material that resists dissolution in a 17.5% solution of sodium hydroxide at 20° C., with the other (dissolved) cellulose materials being beta cellulose and gamma cellulose. For simplicity, in the present document, the term “cellulose” implicitly includes substances comprising at least 50% alpha, beta, and gamma cellulose. The reason for this is because there are myriad fiber-containing substances on the market that are primarily cellulose, but which also contain other substances related to their origin and the extent by which they are processed.

These sources include, for example, pea fiber, wheat-derived cellulose fiber, oat-derived cellulose fiber, sugar beet fiber, bamboo fiber, potato-derived fiber, corn husk-derived fiber, coconut shell fiber, corn bran-derived cellulose fiber, banana leaf fiber, cotton-derived cellulose fiber, wood-derived cellulose fiber, oat fiber, etc. When these sources of cellulose are sufficiently purified, they become more valuable interchangeable commodities. However, even the impure, less-processed sources of cellulose can also be used in the present invention. Market conditions may play a role in ingredient selection along with the details of the specific application. Cellulose fiber lengths vary and are specified by the mesh size that is able to pass a fixed percentage of the fiber. For simplicity, the expression “cellulose-dominant flour” is herein defined as a mixture consisting by dry weight of at least 50% cellulose. Thus, by these definitions, a cellulose-dominant flour has at least 25% alpha, beta, and gamma cellulose.

The notion of a flour-free or low-flour cellulose-based bakery product is unusual. In fact, industry-accepted reference textbooks on cracker, biscuit, and cookie recipes give ingredients, analysis, and even graphs of sugar, moisture, and fat relative to their starch-containing flour content (e.g., Manley 2001). Unlike traditional food products in these textbooks, many of the embodiments of the present invention are starch free. Therefore, they cannot be easily analyzed or discussed by conventional means. In this document, most ingredient weights in recipes for bakery products are presented relative to the weight of cellulose, since it is the often the primary ingredient besides water.

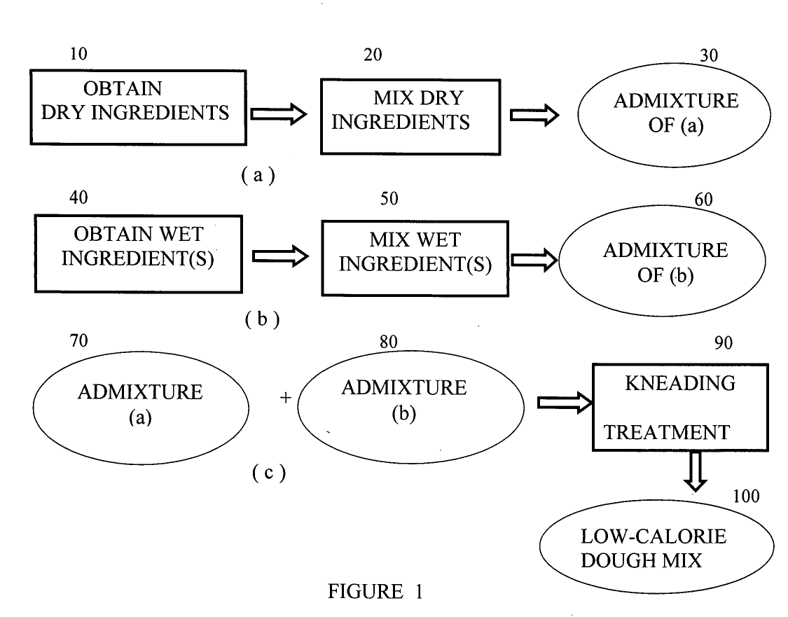

FIG. 1 illustrates certain embodiments of a process by which a low-calorie, somewhat generic, cellulose-based dough mix, may be produced. The depicted embodiment provides a dough mix made from cellulose, water, hemicellulose, methycellulose, and xanthan gum, and additional ingredients, such as flavoring agents. As depicted, the dry ingredients 10 are mixed 20 to form an admixture 30. The wet ingredients 40 are then mixed 50 to form another admixture 60. The two admixtures are then kneaded 90 until the gums and mucilages have bound the water, increased the viscosity, and caused the dough to be sticky. The dough 100 may then be sold or used to make other commercial food products.

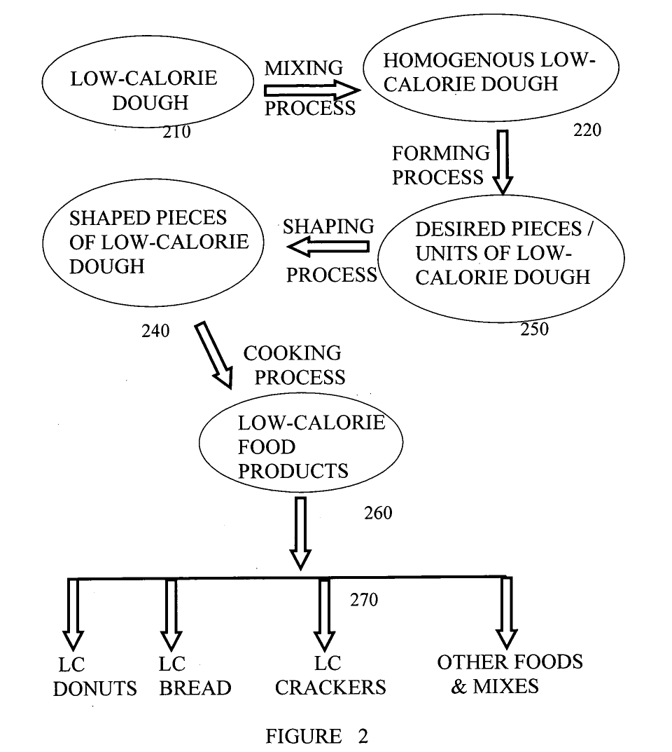

In some embodiments, the low-calorie dough of the present invention is used to form various retail products. One process for doing this is illustrated in FIG. 2. The low-calorie dough 210 is cut 250, shaped 240, cooked 260, cooled, and further processed (e.g., sprayed with flavoring agents) as required for specific applications to form retail products ready for packaging 270. Cooking may be done via conventional means, but also by microwave radiation. During cooking, the chemical leavening agents help transform the dough into an aerated fluffy bread. An additional source of leavening is steam released from heated water. This source is more important for crackers and biscuits made from the invention. In these cases, steam helps form bubbles while the dough cooks and hardens.

During the drying and cooling processes, part of this steam is replaced by air. The methycellulose and xanthan gum of the present invention serve a similar purpose that gluten does in conventional bread: helping to prevent the escape of air from air pockets in the central regions the bakery products. The dough may be cooked by microwave radiation, which we have discovered strengthens the final product.

One embodiment, the dry ingredients of the dough are first thoroughly mixed. Subsequently, the water is added to form dough. The dough is then subjected to a kneading treatment in an electric mixer or mechanical beater for approximately seven minutes at medium speed. At this point, the water amount may again be adjusted to accommodate the specific humidity of the local weather and to keep the dough sufficiently moist. Kneading treatment is continued until dough is tough and there are no dry spots. The kneaded dough is shaped into the targeted product pieces, such as torroidal donuts/doughnuts. These pieces may then be cooked.

The cooking process may be highly product specific. Sensors, including near infrared radiation reflectance, may be used to automatically adjust cooking times in a commercial production facilities fitted to produce the invention.

The present invention will be further demonstrated by the following examples. It should be noted that the invention is by no means limited to these examples.

EXAMPLE 1 of the invention is a very low-calorie donut. It is arguably the most complex and difficult to make of the examples provided in this disclosure, but it has the benefit of containing several different aspects of the invention in one food product. EXAMPLE 1 results in a caloric reduction of approximately 92% (as compared to its regular non-diet counterpart). In addition to the cellulose-based dough, there are two optional additional novel components of EXAMPLE 1: (1) the cellulose-based filling, and (2) the erythritol-based enrobing glaze. The composition for the low-calorie cellulose-based dough is listed in Table 1.

TABLE 1
Low-Calorie Donut Excluding Glaze
and Filling, Dry and Wet Mix

| Ingredient | Ingredient dry weight |
|---|---|
| alpha cellulose fiber, 90-micron mesh | 100.0% |
| finely ground psyllium husk | 15.0% |
| baking powder | 4.8% |
| xanthan gum | 2.5% |
| dried egg whites | 4.2% |
| salt | 1.4% |
| methylcellulose | 1.3% |
| sucralose | 1.0% |
| monoglycerides | 0.7% |
| yellow coloring agent | 0.1% |
| water | 296.1% |
| Total | 427.1% |

Table 1 lists the ingredients of EXAMPLE 1 by weight relative to cellulose fiber. Water is added to the dry mix of ingredients of Table 1 in a ratio of approximately 3 parts water to one part dry weight as the dough is formed and kneaded. For comparison, a conventional bread recipe uses much less water; a ratio of only 0.6 parts water to 1 part flour is reasonable. The exact amount of water may vary because it is a function of the ingredient temperature, humidity, and cooking conditions.

The shaped donuts may be cooked using a microwave oven. An infra-red radiation heating source may also be used. A traditional baking oven can also be used, but convective heating methods have a disadvantage in that they heat the food exterior more than the interior. This can cause long bake times and low baking temperatures for larger bakery products, such as bread loaves and even donuts if the outer and inner sections are to be of similar firmness and moistness. Our experiments also suggest that the microelectric oscillating electric fields from a microwave radiation oven help catalyze crosslinking between next-neighboring polymer chains and proteins in the dough during the cooking process, allowing a firmer crumb and sponge structure than would otherwise exist. This type of crosslinking is actually a normal part of traditional baking processes, with, e.g., ascorbic acid in existing commercial doughs performing a similar function (namely, in this case, in the formation of intermolecular disulfide bonds to gluten). These bonds allow for a final bakery product that is much firmer and moist than would have been otherwise attained. Indeed, our experiments also confirm that a mere replacement of flour with cellulose in significant amounts results in a flat, tough, “papery” product, just as suggested in prior art disclosures.

When microwave radiation is used for cooking, the shaped dough pieces may be placed on microwavable cooking racks. The power per donut can be dependent upon the number of donuts and size of the oven. Cooking at 1300 watts per 71 gram donut for 2.0 minutes (2195 joules or 524 calories per gram of dough, not excluding losses to tray heating) to yield a 38 gram final donut has proven successful. This process results in moderate moisture reduction, especially on the donut edges. The resulting products may then subjected to air-drying treatment at high speed. The products may also be cooled.

Upon completion of the cooking, the cellulose-based filling may be added. The hydrated ingredients of Table 1 can, with minor modification, be used as a base dough that can be used to manufacture several different low-calorie products, including the sweet-tasting donut filling. It should be pointed out that this filling is optional, and, moreover, other fillings, such as low-calorie polydextrose fillings, could also be used. The recipe for the cellulose-based filling is dependent upon the particular flavor of donut filling that is desired. A cellulose-based raspberry-flavored filling can be made starting with the same dry dough mix ingredients of Table 1, but without the coloring, salt, and baking powder ingredients. The resulting dry mix may be added to 1% parts by weight flavoring agents (artificial raspberry flavoring, sucralose, and purple food coloring), 1 part by weight raspberries, and 3 parts by weight of hot water. The filling ingredients are mixed at high shear and then cooled for several hours. This cellulose-based filling is then injected into the donuts using methods well-known in the baking industry.

The final step for EXAMPLE 1 is enrobing the optionally filled donuts. The enrobing glaze is not made from sucrose and water as is typical. Rather, it is a reduced-calorie food “mimetic” (i.e., imitator) of high-sugar sweet confectionery products. Pure erythritol has a melting point of 121° C. (249° F.) and a freezing point of 43° C. (109° F.). When subjected to ordinary room temperature, erythritol crystals form, grow, and merge to form a hard, solid mass. This hardness makes it virtually inedible unless the crystals are very small (e.g., the size of table salt crystals). Upon addition of an impurity such as water, the freezing temperature can be reduced by

$$Δ T = - ( \frac{{RT}_{0}^{2}}{Δ {H}_{f}} ) {χ}_{solute} ,$$

where ΔT is the freezing point change, R is gas law constant, T₀ is the original freezing point (109° F.), ΔH_{f} is the heat of fusion of the solvent (339.8 KJ/Kg in this case), and χₛₒₗᵤₜₑ is the molar concentration of the impurity (e.g., water). Our experiments showed that the freezing temperature is best reduced to include room temperature by employing as impurities hydroscopic gums and water. The erythritol-based glaze of EXAMPLE 1 is made by mixing 83.5% erythritol, 1.5% xanthan gum, and 15.0% water by weight. The dry ingredients are mixed first. Water is then added to this mixture. The mixture is then heated until the erythritol crystals have fully melted and form a bubbling, sticky liquid. This hot liquid glaze is then cooled to approximately 115° F., but above its solidification (freezing) region. The glaze will begin to freeze over a broad range of temperatures due to the crystalline interference of the gum(s) and water. The exact temperature range over which freezing crystal formation occurs is highly sensitive to the amount of water that has been lost to steam formation during the initial heating phase. Additional flavoring agents, 2% sucralose for EXAMPLE 1, may then be added to the hot glaze liquid. The optionally filled donuts are then dipped into liquid or, alternatively, the glaze liquid is poured on the donuts. Additional and optional flavoring and textural novelties may then be added via spraying, direct touching, brushing the surface of the warm glaze surface, or the like. The enrobed donuts may then be cooled as the erythritol-based glaze hardens and partially solidifies to form a glaze that remarkably similar in both texture and taste to a traditional, high-calorie, sucrose-based one.

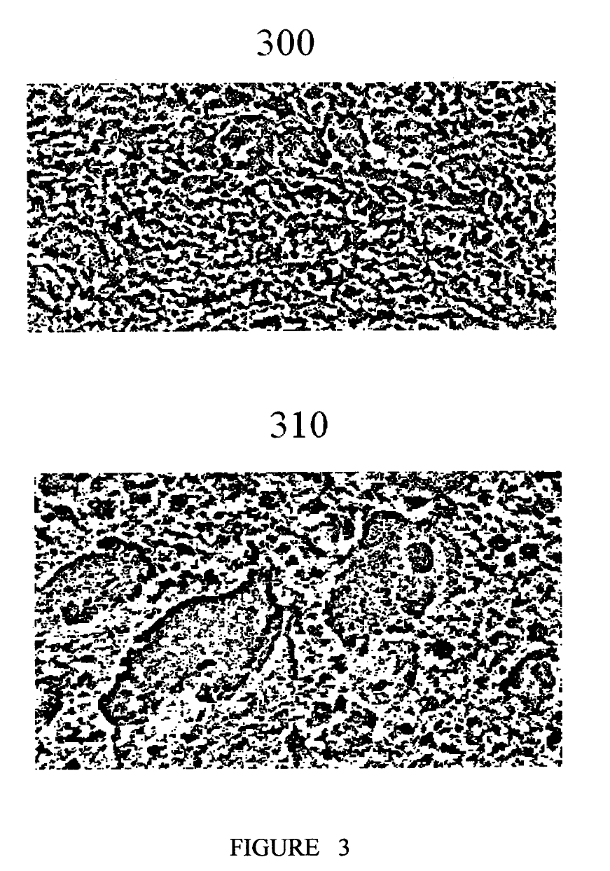

A cross-sectional view of EXAMPLE 1 is shown 310 in FIG. 3 above a prior art donut 300. This donut was constructed in the optional non-filled toroidal form since the filling structure is not of interest. Shown in the bottom section of FIG. 3 for comparison is a cross-sectional view of a donut. Note that the aeration is significant in both products. These air pockets give each product a soft mouthfeel. This allows for a similar crumbly, somewhat weak and easy to chew, texture.

EXAMPLE 2 is a low-calorie bread. Table 2 lists the ingredients for this embodiment of the invention.

TABLE 2
Low-Calorie Bread

| Ingredient | Ingredient by weight |
|---|---|
| alpha cellulose fiber, 90-micron mesh | 100.0% |
| finely ground psyllium husk | 15.0% |
| baking powder | 4.8% |
| xanthan gum | 2.5% |
| salt | 1.4% |
| methylcellulose | 1.3% |
| food coloring | 0.04% |
| sucralose | 0.03% |
| water | 296.1% |
| Total | 424.0% |

For this embodiment of the invention, the measured ingredients are again segregated into the dry and wet ingredients respectively. In the first stage the dry ingredients are first thoroughly mixed followed by the subsequent addition of the wet ingredients. The resulting mass is subjected to a kneading treatment to form a soft elastic dough mass. Unless the proper physical properties are obtained at this stage, the dough may be very difficult to manipulate, either by hand or by machinery, and may not produce bread of optimal volume and texture. Adequately developed bread dough will exhibit a slight sheen on the surface but will be only slightly sticky to the touch. When the dough is stretched out to a thin film, it will not tear readily and will have a translucent, webbed appearance when viewed against the light. This phase is often referred to as the developing of the dough.

In certain embodiments of the invention, yeast could be used instead of chemical leavening agents. However, since yeast requires sugar, and will generally only ferment a small fraction of that sugar, yeast-based leavening systems will have slightly more calories than chemical ones. Yeast-based leavening requires that the dough be subjected to a fermentation treatment using the standard fermentative organisms, which results in expanding of the dough. The fermented dough would again be subjected to kneading so that most of the carbon dioxide is pressed out of it. This helps reduce the formation of large gas bubbles, which mar the appearance and texture of the loaf. Regardless of the leavening system used, the bulk dough mass is then cut into pieces of a size yielding the desired size of roll or loaf. This may be followed by heat treatment which could be a microwave oven, an infra-red radiation heating source, or a convective heating oven to achieve optimal cooking.

Low-calorie crackers (i.e., low-fat, low-sugar biscuits) and cookies are other embodiments of the invention. EXAMPLE 3 of the invention is a low-calorie cracker. Its ingredients are listed in Table 3.

TABLE 3
Low-Calorie Cracker

| Ingredient | Ingredient by weight |
|---|---|
| 70-micron mesh alpha cellulose fiber | 100.0% |
| finely ground psyllium husk | 19.3% |
| silicon dioxide | 16.7% |
| baking powder | 9.5% |
| high-amylose starch | 8.6% |
| methylcellulose | 4.1% |
| xanthan gum | 1.8% |
| salt | 1.6% |
| guar gum | 0.8% |
| sucralose | 0.5% |
| autolyzed yeast extract | 0.3% |
| yellow food coloring | 0.2% |
| water | 281.0% |
| Total | 444.5% |

The ingredients listed in Table 3 may be mixed to form a dough and then pressed and cut into cracker-shaped pieces. The shaped dough pieces may be microwaved until moisture levels reduce to approximately 3%. Subsequently, the crackers may then be cooled slowly to minimize shrinkage.

Other embodiments of the invention but without as many of the disadvantageous characteristics sometimes associated with baking powder or traditional leavening agents (such as yeast, sugar, or bitter aftertastes) employ chilled aerated water, such as seltzer water, instead of filtered water. For testing purposes in which shelf life is especially important, inert or oxygen-free gas may be utilized. The general process for making these reduced-leavening cracker, bread, or extruded embodiments of the invention is to replace the water and 50% of the baking powder in EXAMPLE 3 with, by weight, 70% water or seltzer water near 0° C. The ingredients are placed in a sealed vessel. The ingredients are then mixed at low speed until the temperature has risen to approximately 30° C. The dough is then shaped into crackers or loaves. The mixing vessel is then depressurized, causing the dough to expand and form a foam. The foam may then be cooked as the product hardens and further expands. The products may then be dried, cooled, and sprayed with optionally colored flavorings.

Similar techniques are used to create extruded low-calorie, reduced-leavening embodiments of the invention. Extruded crunchy snacks normally expand via steam creation at the die upon exposure to pressure reduction and consequent super-heated water. As this steam inside the collet eventually condenses into water, the expanded collet may shrink and crack from the vacuum. This results in imperfect texture and mouthfeel. The present invention may improve the situation by replacing part of the expanding steam with other gas, such as carbon dioxide and diatomic nitrogen which, unlike steam, remain gaseous at room temperature.

Existing puffed snacks are mostly starch. In one extruded embodiment of the invention, the feedstock consists of 50% of the mixed dry ingredients of EXAMPLE 1 excluding sucralose, 45% ground corn, 4% tapioca starch, and 1.0% monoglyceride. This dry feedstock is placed into the holding bin. From there it is dispensed into the preconditioner, where the chilled aerated water at 0° C. is added to make a 14% feedstock during a brief mixing phase that is ideally pressurized. From there it enters, preferably without any pressure reduction, the feed zone of the extruder barrel(s) before being further kneaded, heated, pressurized, and extruded. In one embodiment, a twin-screw extruder, such as Wenger Manufacturing's C²TX-8.1 may be used due to its relatively flexible operational range as compared to single-screw extruders. A more conventional extruded embodiment of the invention that may be easier to produce simply omits the use of pressurized mixing and water with significant dissolved gas.

Another extruded food embodiment of the invention consists of a tri-layered extruded food with a low-calorie, high-moisture filling. High moisture fillings within a low-moisture crispy extruded food would traditionally not have a significant shelf life or even be possible to create due to the diffusion of moisture from the inside filling to the external layer of the extruded food. This embodiment of the invention has a moisture and heat barrier around the filling and between the cellulose-based crispy exterior to protect it during both the drying phase of the product manufacturing. In order to not excessively cook the internal filling during the extrusion process, a middle layer that is thick enough to have an insulatory R-value greater than 0.00050 ft²° F./(BTU/hr) is preferred.

The present invention may also serve as a substitute to starch-containing foods. Starch is such a ubiquitous component of normal foods that this basic cellulose-based dough of the invention can be used in many different food products, such as a flavorful low-fat dip.

A further embodiment of the invention may be as a calorie-reducing mixing agent in other foods. One such embodiment is EXAMPLE 4, which is a low-calorie cheese and tomato-flavored dip. Table 4 lists its ingredients.

TABLE 4
Low-Calorie Non-Dairy Tomato-Flavored Cheese Dip

| Ingredient | Ingredients by weight |
|---|---|
| 70-micron cellulose fiber | 35.0% |
| previously prepared salsa | 32.1% |
| water | 22.8% |
| cheese flavoring | 3.5% |
| monoglycerides | 2.2% |
| guar gum | 1.6% |
| xanthan gum | 1.6% |
| autolyzed yeast extract | 1.0% |
| sucralose | 0.1% |
| food coloring | 0.1% |
| Total | 100.0% |

EXAMPLE 4 can, with modifications (namely, replacing the prepared salsa and flavoring agents), also serve as a partial substitute in many recipes historically relying on high levels of starch, fat, pectin, or gelling agents to obtain the textural properties of a food product. Note that these embodiments of the invention have recipes that are very similar to the above listed example, but are modified to allow the creation of any of the reduced-calorie foods selected from the following group: artificial bacon, bagels, biscotti, bread, bread sticks, breakfast cereals, buns, chewable candies, chewable tablets, chips, chocolates, cookies, condiments, crackers, croutons, cupcakes, extruded candies, other extruded foods, extruded protein nuggets, extruded crunchy snacks, fruit wraps, hamburger buns, hotdog buns, ice cream inclusions, ice creams, jams, meat balls, muffins, nut butter spreads, pasta products, pie crusts, pie fillings, pita bread, pizza crusts, pretzels, protein bars, snack bars, candy bars, diet bars, breakfast bars, sauces, structural meat analogs, tortilla wraps, flavored dips, and flavored food pastes.

Moreover, to conform to market demands or increase the variety available to the consumer, combinations of these foods may be also be constructed as different embodiments of the invention. In any of these embodiments of the invention, the water content of the recipe may be increased as compared to the bakery product embodiments to form pastes of the desired viscosities.

As EXAMPLE 4 illustrates, the psyllium husk/hemicellulose, silicon dioxide, and leavening agents, may be reduced or removed entirely. Heating and mixing may be performed. The resultant paste may be mixed with flavoring, nutritive, and textural agents. These agents include curry powder, sucralose, red hot peppers, salsa, fruits, flavorants, coloring agents, nuts, meats, other vegetables, fats, other flavoring agents, or mixtures thereof. The paste may be normally cooled and set until it firms (several hours). In some applications (e.g., a low-calorie pizza sauce or pasta filling), the product may again be heated before being prepared for packaging or serving. Caloric reductions of 0-90% of common paste-like foods may be attainable via this embodiment of the invention.

A further embodiment of the invention may be a low-calorie extruded product, such as a low-moisture, low-calorie, savory snack. This embodiment may be produced by mixing 1 part cellulose-based dough (as in EXAMPLE 1 but with less sweetening agents and a finer mesh cellulose, such as a 98%-passing 50 micron cellulose fiber) with 1 part original dough. In such embodiments, reduced-calorie extruded products may be made by placing the reduced-calorie dough in a die-containing extrusion machine. The mixed dough may be subjected to high pressure before being release in a largely steam-driven expansion. It may then be sprayed with flavoring and coloring agents. Dissolved gas, such as carbon dioxide and/or nitrogen, may be added to a wet ingredient before being mixed and extruded. This allows enhanced texture and reduced drying times. In such embodiments, it may be important that the product is well-mixed just prior to exiting the die, as even small inhomogeneities can result in large irregularities of output. The fractional extent by which the generic cellulose dough or paste base may be mixed with a traditional recipe for the final product determines the extent of caloric reduction that may be attained.

Research has shown that the caloric reduction bears a close relationship to the amount of non-surface flavoring enrichment that may also be required. For extruded low-calorie snack foods embodiments that utilize a cellulose-based dough mix, an additional means of calorie reduction can be attained by using Olestra® or sucrose polyester as a flavor mix binding agent after moisture reduction has completed.

EXAMPLE 5 is additional example of the invention. It is a high-protein, low-calorie cake. The ingredients for this example provided in Table 5.

TABLE 5
Low-Calorie, High Protein Cake Mix, Wet Mix

| Ingredient | Ingredient by weight |
|---|---|
| water | 34.4% |
| fat-free milk | 24.4% |
| raw egg white | 14.2% |
| 90-micron mesh alpha cellulose fiber | 12.0% |
| finely ground psyllium husk | 3.2% |
| baking powder | 2.3% |
| sucralose | 1.2% |
| monoglycerides | 0.7% |
| vanilla extract | 0.7% |
| salt | 0.5% |
| diced coconut | 0.3% |
| yellow coloring agent | 0.1% |
| Total | 100% |

In EXAMPLE 5, the ingredients may be mixed as before, but then may be blended at high speed for only 60 seconds before being immediately cooked. Instead of using heating racks, the batter may be placed in plastic container(s) while being cooked via microwave radiation. Other heating methods could also be employed. Upon cooling, the hot liquid erythritol enrobing glaze mixture similar to that described in EXAMPLE 1 may be applied to the top and side surfaces. The cake may then again be quickly air cooled and sprayed with additional flavoring agents. EXAMPLE 5 has approximately 88% fewer calories than the regular versions of this cake.

It is understood that various omissions, substitutions of equivalents are contemplated as circumstances may suggest or render expedient, but is intended to cover the application or implementation without departing from the spirit or scope of the claims of the present invention. Thus, the present invention is intended to include within its ambit myriad low-calorie products in addition to those explicitly mentioned.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A mix for making reduced-calorie food comprising by dry weight of at least about 30% of a fiber that is at least 50% cellulose, and less than about 40% hydrocolloids.

2. The mix of claim 1, wherein most of the particle sizes of said fiber are smaller than about 90 microns.

3. The mix of claim 1, wherein said fiber is selected from the group consisting of
pea fiber,
bamboo fiber,
alpha cellulose,
beta cellulose,
wheat-derived cellulose fiber,
oat-derived cellulose fiber,
potato-derived fiber,
corn husk-derived fiber,
cotton-derived cellulose fiber,
sugar beet fiber,
wood-derived cellulose fiber, and
combinations comprising at least one of the foregoing.

4. The mix of claim 1, further comprising at least one substance selected from the group consisting of
psyllium husk,
wheat gluten,
water,
wheat bran,
hemicellulose,
oat bran,
egg whites,
pea flour,
a heat-stable sweetening mixture,
silicon dioxide,
a leavening agent, and
an edible filling assemblage.

5. The mix of claim 4, wherein said edible filling assemblage comprises a filling selected from the group consisting of
a polydextrose-based filling,
a gelatin-based filling,
a gum-based filling, and
a filling consisting primarily of water and a cellulose-based fiber.

6. The mix of claim 4, wherein said heat-stable sweetening mixture comprises at least one ingredient selected from the group consisting of
tagatose,
acesulfame potassium,
aspartame,
neotame,
saccharin,
sucralose,
sorbitol,
mannitol,
isomalt,
dextrose,
fructose,
polydextrose, and
sugar.

7. The mix of claim 4, wherein said leavening agent comprises at least one ingredient selected from the group consisting of
sodium bicarbonate,
calcium carbonate,
sodium aluminum phosphate,
sodium aluminum sulfate,
monocalcium phosphate, and
an acid.

8. A product made from the mix of claim 1, wherein said mix is further comprised of at least about 10% silicon dioxide.

9. A product made from the mix of claim 1.

10. The process of creating the product of claim 9, comprising the steps of:
a. mixing the dough of claim 1,
b. kneading the dough of step (a), and
c. internally heating the dough of step (b) using microwave radiation, infra-red radiation, or convective heating.

11. The product of claim 9, wherein the dough is baked and shaped to form at least one reduced-calorie donut.

12. The bakery product of claim 9, wherein the dough is baked and shaped to form at least one reduced-calorie cracker.

13. The bakery product of claim 9, wherein the dough is baked and shaped to form reduced-calorie bread.

14. A product made from the mix of claim 1, said product being a reduced-calorie food comprising
a reduced-calorie artificial bacon piece;
a reduced-calorie bagel;
a reduced-calorie biscotti;
a reduced-calorie bread loaf;
a reduced-calorie bread stick;
a reduced-calorie breakfast cereal;
a reduced-calorie bun;
a reduced-calorie cake;
a reduced-calorie cheese;
a reduced-calorie chewable candy;
a reduced-calorie chewable tablet;
a reduced-calorie chocolate;
a reduced-calorie cookie;
a reduced-calorie condiment;
a reduced-calorie cracker;
a reduced-calorie crouton;
a reduced-calorie cupcake;
a reduced-calorie dough;
a reduced-calorie donut;
a reduced-calorie, extruded candy;
a reduced-calorie, extruded food;
a reduced-calorie, extruded, high-protein nugget;
a reduced-calorie, extruded, puffed, crunchy snack;
a reduced-calorie filling assemblage;
a reduced-calorie flavored dip;
a reduced-calorie flavored paste;
a reduced-calorie foodstuff;
a reduced-calorie fruit wrap;
a reduced-calorie hamburger bun;
a reduced-calorie hotdog bun;
a reduced-calorie ice cream inclusion;
a reduced-calorie jam;
a reduced-calorie meat ball;
a reduced-calorie muffin;
a reduced-calorie nut butter spread;
a reduced-calorie pasta product;
a reduced-calorie pie crust;
a reduced-calorie pie filling;
a reduced-calorie pita bread;
a reduced-calorie pizza crust;
a reduced-calorie pretzel;
a reduced-calorie protein, snack, candy, diet, or breakfast bar;
a reduced-calorie ready-to-bake dough;
a reduced-calorie ready-to-bake dough with at least one filling assemblage;
a reduced-calorie sauce;
a reduced-calorie snack chip;
a reduced-calorie structural meat analog; a reduced-calorie tortilla wrap; or a combination thereof.

15. A product made from the mix of claim 1, said product being a reduced-calorie extruded, crunchy snack that has been sprayed or coated with a substance comprising sucrose polyester.

16. A mix for a reduced-calorie food mimetic of traditionally high-sugar confectioneries or sweet inclusions, said mix comprising by weight about 30-97% erythritol.

17. The mix of claim 16, further comprising by weight about 3-70% one or more additional ingredients that act to partially reduce the sizes of or eliminate entirely any solid erythritol crystals that form in said mix when said mix is cooled to a temperature of 30° C. from a temperature of 130° C. at an absolute pressure of 1 bar.

18. The mix of claim 17, wherein said additional ingredients comprise by weight about 0.5-10% hydrocolloids, about 1-20% water, and from zero to 68.5% of a cellulose-based fiber.

19. The mix of claim 18, wherein said hydrocolloids include at least one of the following ingredients:
xanthan gum,
guar gum,
gracalaria agar,
gellan gum,
gum arabic,
inulin,
locust bean gum,
gum tragacanth,
cellulose gum,
methylhydroxypropylcellulose,
galactomannan, and
any other like material.

20. A process of using the mix of claim 16, wherein said process creates a reduced-calorie food mimetic of high-sugar foods and consists of the following steps:
a. mixing said mix with a water-dominant liquid to form a mixture;
b. heating said mixture until the erythritol has dissolved or melted;
c. placing said mixture in its target application; and
d. cooling said mixture until it hardens or thickens by an amount desired.

21. A product made from the process of claim 20, said product including at least one of the following:
reduced-calorie confectionery inclusions,
toppings,
layers,
fondants,
chips,
whole confectioneries,
glazes,
candies,
caramels,
confectionery instant mixes, and
other foods.

22. The product made from the process of claim 20, said target application being a reduced-calorie enrobing glaze for pastry and pastry-like food products.

23. A product made from the process of claim 20, wherein said target application is as at least one confectionery layer, inclusion, enrobing of a reduced-calorie protein, snack, candy, diet, or breakfast bar food.

24. A product made from the process of claim 20, wherein an additional step is added between steps {c} and {d} of adding into and mixing a flavorant combination consisting of sucralose and vanilla into the liquid glaze.

25. The bakery product of claim 22, wherein the product is a reduced-calorie bakery product comprising by dry weight at least about 30% of a fiber that is at least 50% cellulose, and less than about 40% hydrocolloids.

26. A process for producing a bakery product comprising mixing ingredients with either:
a. compressed gas, or
b. a liquid that contains enough dissolved gas to have a total dissolved gas vapor pressure greater than about 2 bars of absolute pressure if brought to a temperature 30° C.

27. The process of claim 26, wherein at least part of said mixing is conducted at an absolute pressure that is greater than about 2 bars.

28. A product made from the process of claim 26, wherein the product is a reduced-calorie extruded snack food.

29. A product made from the process of claim 26, wherein the product is a reduced-calorie bakery product.

30. A product made from the process of claim 26, wherein the product is a reduced-calorie bakery product with an erythritol-based enrobing glaze or frosting.

31. An extruded food consisting of a filling that is at least partially surrounded by two or more layers wherein the middle layer(s) decrease(s) the diffusion rate of water moisture from the filling to the outermost layer by at least 50% and the transfer rate of heat due to any temperature differences between the outermost layer and the core by at least 30%.

32. The food of claim 31, wherein said middle layer(s) has an R-value greater than approximately 0.0005 feet²° F./(BTU/hr).

33. The food of claim 31, wherein said filling has a fat content below approximately 75% and a moisture content of at least approximately 25%.

34. The food of claim 32, wherein the outer layer is extruded from a cellulose-based feedstock.

35. The process of creating the product of claim 31, comprising the steps of
a. creating a bi-layered extruded product, and
b. using a bi-layered extrusion die with an input line containing said bi-layered extruded product of step (a) to create a tri-layered extruded product.

36. The process of creating the product of claim 31, wherein there is one middle layer and comprising the steps of extruding said filling, said middle layer, and said outermost layer in a tri-layered extrusion device that comprises a bi-ringed tube within a cooking zone of a larger extrusion flow.
